(19) United States
(12) Patent Application Publication
(10) Pub. No.: US 2026/0097382 A1
(43) Pub. Date: Apr. 9, 2026

(54) COATED COMPONENTS FOR COKE ABATEMENT IN GAS TURBINE ENGINES

(71) Applicant: General Electric Company, Evendale, OH (US)

(72) Inventors: Sanat Chandra Maiti, Kolaghat (IN); Atanu Saha, Bengaluru (IN); Karthick Gourishankar, Bengaluru (IN); Sanjay Kumar Sondhi, Bengaluru (IN)

(21) Appl. No.: 18/897,559

(22) Filed: Sep. 26, 2024

(30) Foreign Application Priority Data
Apr. 9, 2024 (IN) 202411028864

(51) Int. Cl. B01J 19/00; F01D 25/00

(52) U.S. Cl. CPC B01J 19/0026; F01D 25/005; F05D 2230/22; F05D 2230/90; F05D 2260/607; F05D 2300/21; F05D 2300/514; F05D 2300/609

(57) ABSTRACT

A coated component for coke abatement in a gas turbine engine. The coated component includes a substrate, and a catalytic coating. The catalytic coating has a first layer in contact with the substrate, the first layer including a first ceramic material and a first noble metal, a second layer in contact with the first layer, the second layer including a second ceramic material and a second noble metal, and a third layer in contact with the second layer, the third layer including a third ceramic material and a third noble metal. The first layer has a plurality of grains having an average diameter, and the first layer has a volume percent porosity. The second layer has a plurality of grains having a bimodal distribution, and the second layer has a volume percent porosity. The third layer has a plurality of grains having an average diameter, and a volume percent porosity.

### CROSS REFERENCE TO RELATED APPLICATIONS

The present application claims the benefit of Indian Patent Application No. 202411028864, filed on April 9, 2024, which is hereby incorporated by reference herein in its entirety.

### TECHNICAL FIELD

The present disclosure relates to coated components including a substrate and a catalytic coating, and methods using the coated components for coke abatement, for example, in gas turbine engines for aircraft.

### BACKGROUND

Gas turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in coke becoming attached to surfaces contacted by a fuel or oil and building up as deposits on those surfaces contacted by a fuel or oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having a gas turbine engine according to an embodiment of the present disclosure.

FIG. 2 is a cross-sectional view taken along line 2-2 in FIG. 1, of the gas turbine engine of the aircraft shown in FIG. 2.

FIG. 3 is a cross-sectional view of a combustor of the gas turbine engine shown in FIG. 2 according to an embodiment of the present disclosure. FIG. 3 is a detail view showing detail 3 in FIG. 2.

FIG. 4 is a cross-sectional view of a mixer assembly of the combustor in FIG. 3. FIG. 4 is a detail view showing detail 4 in FIG. 3.

FIG. 5 is a cross-sectional view of a combustor of the gas turbine engine shown in FIG. 2 according to another embodiment of the present disclosure.

FIG. 6 is a cross-sectional view of a mixer assembly of the combustor in FIG. 5. FIG. 6 is a detail view showing detail 6 in FIG. 5.

FIG. 7 is a cross-sectional view of a catalytic coating applied on surfaces of a venturi and an aft heat shield.

FIG. 8A is a cross-sectional view of a catalytic coating applied on a substrate.

FIG. 8B is a cross-sectional view of a catalytic coating applied on a substrate having a ceramic coating.

FIG. 9 is a cross-sectional view of a catalytic coating having one or more layers.

FIG. 10A depicts a coated surface after an air impingement test.

FIG. 10B depicts a coated surface after an air impingement test.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing the present disclosure.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “fluid” may be a gas or a liquid. The term “fluid communication” means that a fluid is capable of making the connection between the areas specified.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The term “noble metal” refers to the elements rhenium, ruthenium, rhodium, palladium, silver, osmium, iridium, platinum, and gold.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy.

As used herein, a region of a material is a connected subset of the material having an approximately uniform composition.

As used herein, a region of a material may contain one or more “grains” having an approximately uniform composition and structure. A crystallite is an example of a grain. The average grain size of a material can be determined by, for example, electron microscopy. The diameter of a grain is the diameter of the smallest sphere enclosing the grain.

As used herein, a “mode diameter” of a plurality of grains having a multimodal size distribution is a diameter corresponding to a peak in the probability density function for the diameters of the plurality of grains. A bimodal size distribution is an example of a multimodal size distribution.

As used herein, coke is selectively oxidized by a catalytic coating in the presence of a hydrocarbon fuel if the reaction rate of coke oxidation by the catalytic coating is higher than the reaction rate of hydrocarbon fuel by the catalytic coating.

As used herein, “flash sintering” refers to a process for sintering a coating wherein the coating has a thermal gradient through the thickness of the coating. In some embodiments, flash sintering may be performed by heating one side of a coating and cooling the opposite side of the coating. In some embodiments, flash sintering may be performed by heating one side of a coating for a period of time that is short enough that a uniform temperature does not develop through the thickness of the coating, and such heating steps can be performed repeatedly for, for example, from two to ten heating cycles. Any of the disclosed sintering steps recited in this disclosure may be a flash sintering step.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other.

As noted above, coke deposition may occur on surfaces of a gas turbine engine that are exposed to hydrocarbon fluids, such as fuels and lubricating oils, at elevated temperatures. The fuel nozzle and swirler (collectively, a mixer assembly) used in a combustor for a gas turbine engine includes such surfaces. The fuel nozzle aft heat shield (FN-AHS) protects the fuel nozzle from hot combustion gases during engine operation. Surfaces of the FN-AHS and other surfaces of the mixer assembly such as the fuel nozzle venturi are exposed to hydrocarbon fluids, such as fuel, and operation of the gas turbine engine, particularly, continuous operation at cruise for aircraft gas turbine engines, can result in significant build-up of coke and/or partially burned fuel deposits on exposed surfaces of the FN-AHS and the mixer assembly.

Coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) may result in spallation of the thermal barrier coating and may reduce the durability of components such as combustors, nozzles, shrouds, and airfoils. The coke deposits can be reduced or eliminated using a catalytic coating capable of catalyzing a degradation reaction of coke such as, for example, coke oxidation. For example, coke oxidation may convert solid coke deposits to gaseous reaction products because coke oxidation may include the reaction of carbon with diatomic oxygen to form reaction products such as carbon monoxide and carbon dioxide. Without a catalytic coating capable of catalyzing a degradation reaction of coke, coke may build up on a surface and degrade the performance of systems and components.

Disclosed herein are catalytic coatings that can be applied to various surfaces and components to reduce the buildup of coke thereon. The catalytic coatings include three layers, and each layer has a ceramic material and noble a metal such that the catalytic coating is catalytically active. Volume percent porosities and grain sizes of each of the layers are tailored to improve durability of the catalytic coatings when the catalytic coating is applied to a substrate such as a surface or a portion of a component. Some non-limiting examples of suitable surfaces and components include aircraft components, gas turbine engine components, lube oil system components, fuel passage components, fuel circuit components, fuel nozzles (e.g., a venturi surface on the fuel nozzle), mixer assembly components, and aft heat shields. The gas turbine may be a gas turbine for an aircraft or may be a terrestrial turbine such as for a power plant, or a maritime gas turbine engine for a ship. Some such components are described in more detail below.

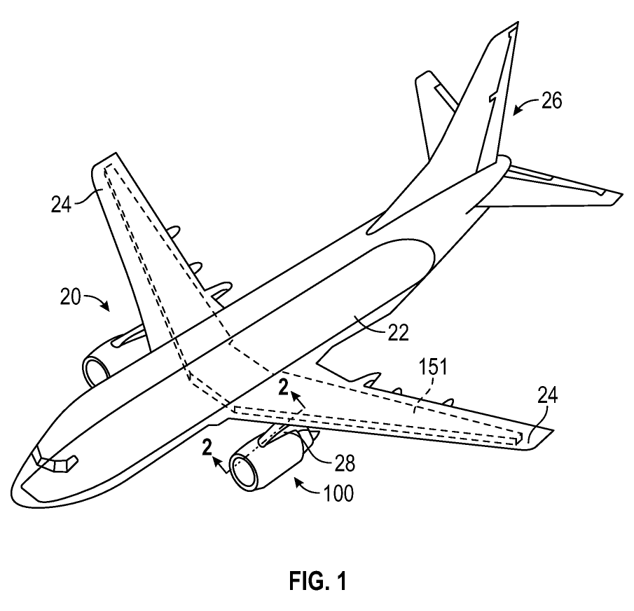

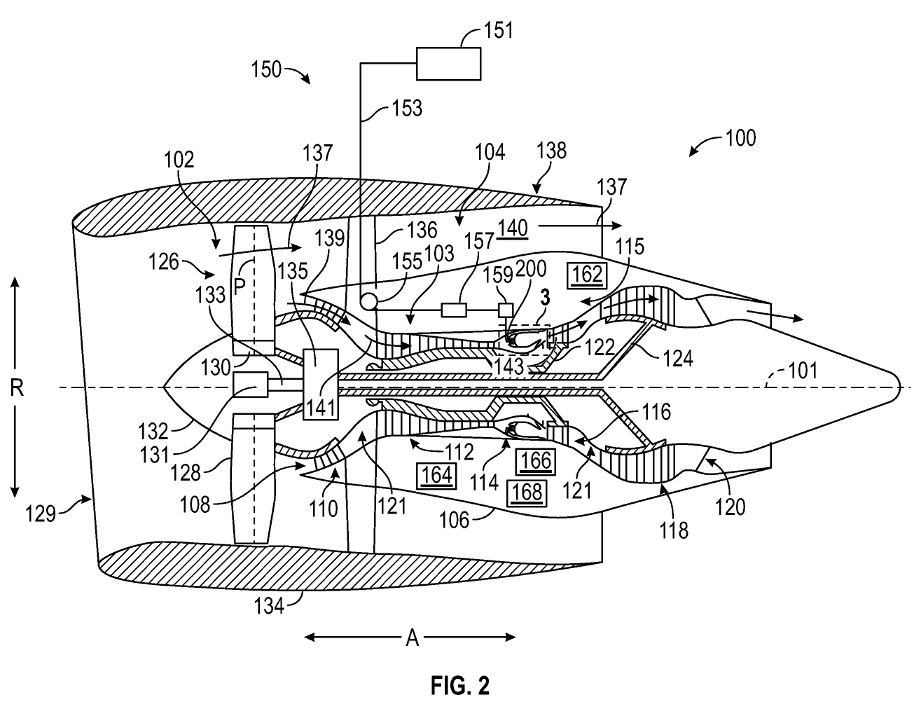

FIG. 1 shows an aircraft 20 that may implement various embodiments. The aircraft 20 includes a fuselage 22, wings 24 attached to the fuselage 22, and an empennage 26. The aircraft 20 also includes a propulsion system that produces a propulsive thrust required to propel the aircraft 20 in flight, during taxiing operations, and the like. The propulsion system for the aircraft 20 shown in FIG. 2 includes a pair of engines 100. In this embodiment, each engine 100 is attached to one of the wings 24 by a pylon 28 in an under-wing configuration. Although the engines 100 are shown attached to the wing 24 in an under-wing configuration in FIG. 1, in other embodiments, the engine 100 may have alternative configurations and be coupled to other portions of the aircraft 20. For example, the engine 100 may additionally or alternatively include one or more aspects coupled to other parts of the aircraft 20, such as, for example, the empennage 26, and the fuselage 22.

As will be described further below, with reference to FIG. 2, the engines 100 shown in FIG. 1 are gas turbine engines that are each capable of selectively generating a propulsive thrust for the aircraft 20. The amount of propulsive thrust may be controlled at least in part based on a volume of fuel provided to the engine 100 (e.g., a gas turbine engine) via a fuel system 150 (see FIG. 2). An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. The fuel is stored in a fuel tank 151 of the fuel system 150. As shown in FIG. 1, at least a portion of the fuel tank 151 is located in each wing 24 and a portion of the fuel tank 151 is located in the fuselage 22 between the wings 24. The fuel tank 151, however, may be located at other suitable locations in the fuselage 22 or the wing 24. The fuel tank 151 may also be located entirely within the fuselage 22 or the wing 24. The fuel tank 151 may also be separate tanks instead of a single, unitary body, such as, for example, two tanks each located within a corresponding wing 24.

Although the aircraft 20 shown in FIG. 1 is an airplane, the embodiments described herein may also be applicable to other aircraft 20, including, for example, helicopters and unmanned aerial vehicles (UAV). The aircraft discussed herein are fixed-wing aircraft or rotor aircraft that generate lift by aerodynamic forces acting on, for example, a fixed wing (e.g., the wing 24) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the engines 100 used in the propulsion system for the aircraft 20 shown in FIG. 1. The cross-sectional view of FIG. 2 is taken along line 2-2 in FIG. 1. For the embodiment depicted in FIG. 2, the engine 100 is a high bypass engine. The engine 100 has an axial direction A (extending parallel to a longitudinal centerline axis 101, shown for reference in FIG. 2), a radial direction R, and a circumferential direction. The circumferential direction (not depicted in FIG. 2) extends in a direction rotating about the axial direction A. The engine 100 includes a fan section 102 and a turbo-engine 104 disposed downstream from the fan section 102.

The turbo-engine 104 depicted in FIG. 2 includes, in serial flow relationship, a compressor section 103, a combustion section 114, and a turbine section 115. The turbo-engine 104 is substantially enclosed within an outer casing 106 that is substantially tubular and defines a core inlet 108. The core inlet 108 is annular in the depicted embodiment. As schematically shown in FIG. 2, the compressor section 103 includes a booster or a low pressure (LP) compressor 110 followed downstream by a high pressure (HP) compressor 112. The combustion section 114 is downstream of the compressor section 103. The turbine section 115 is downstream of the combustion section 114 and includes a high pressure (HP) turbine 116 followed downstream by a low pressure (LP) turbine 118. The turbo-engine 104 further includes a jet exhaust nozzle section 120 that is downstream of the turbine section 115, a high-pressure (HP) shaft 122 or a spool, and a low-pressure (LP) shaft 124. The HP shaft 122 drivingly connects the HP turbine 116 to the HP compressor 112. The HP turbine 116 and the HP compressor 112 rotate in unison through the HP shaft 122. The LP shaft 124 drivingly connects the LP turbine 118 to the LP compressor 110. The LP turbine 118 and the LP compressor 110 rotate in unison through the LP shaft 124. The compressor section 103, the combustion section 114, the turbine section 115, and the jet exhaust nozzle section 120 together define a core air flow path 121 through which core air 139 flows.

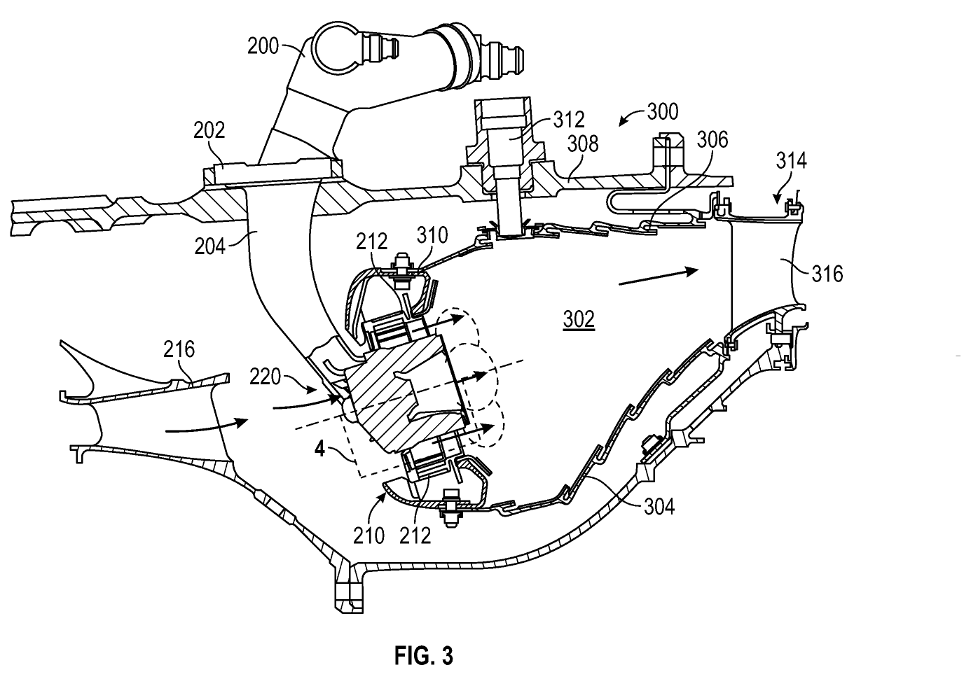

The fan section 102 shown in FIG. 2 includes a fan 126 (e.g., a variable pitch fan) having a plurality of fan blades 128 coupled to a disk 130 in a spaced apart manner. As depicted in FIG. 2, the fan blades 128 extend outwardly from the disk 130 generally along the radial direction R. In the case of a variable pitch fan, the plurality of fan blades 128 are rotatable relative to the disk 130 about a pitch axis P by virtue of the fan blades 128 being operatively coupled to an actuation member 131 configured to collectively vary the pitch of the fan blades 128 in unison. The fan blades 128, the disk 130, and the actuation member 131 are together rotatable about the longitudinal centerline axis 101 via a fan shaft 133 that is powered by the LP shaft 124 across a power gearbox, also referred to as a gearbox assembly 135. In this way, the fan 126 is drivingly coupled to, and powered by, the turbo-engine 104, and the engine 100 is an indirect drive engine. The gearbox assembly 135 is shown schematically in FIG. 3. The gearbox assembly 135 may be a reduction gearbox assembly for adjusting the rotational speed of the fan shaft 133 and, thus, the fan 126 relative to the LP shaft 124 when power is transferred from the LP shaft 124 to the fan shaft 133.

Referring still to the exemplary embodiment of FIG. 2, the disk 130 is covered by a fan hub 132 that is aerodynamically contoured to promote an airflow through the plurality of fan blades 128. In addition, the fan section 102 includes an annular fan casing or a nacelle 134 that circumferentially surrounds the fan 126 and at least a portion of the turbo-engine 104. The nacelle 134 is supported relative to the turbo-engine 104 by a plurality of outlet guide vanes 136 that are circumferentially spaced about the nacelle 134 and the turbo-engine 104. Moreover, a downstream section 138 of the nacelle 134 extends over an outer portion of the turbo-engine 104, and, with the outer casing 106, defines a bypass airflow passage 140 therebetween.

During operation of the engine 100, a volume of air enters the turbine engine (e.g., engine 100) through an engine inlet 129 of the nacelle 134 or the fan section 102. As the volume of air passes across the fan blades 128, a first portion of air, also referred to as bypass air 137, is routed into the bypass airflow passage 140, and a second portion of air, also referred to as core air 139, is routed into the upstream section of the core air flow path 121 through the core inlet 108 of the LP compressor 110. The ratio between the bypass air 137 and the core air 139 is commonly known as a bypass ratio. The pressure of the core air 139 is then increased in the compressor section 103 and, more specifically, the LP compressor 110, generating compressed air 141. The compressed air 141 is routed through the HP compressor 112, where the compressed air 141 is further compressed, and into the combustion section 114, where the compressed air 141 is mixed with fuel and ignited to generate combustion gases 143.

The combustion gases 143 are routed into the HP turbine 116 and expanded through the HP turbine 116 where a portion of thermal energy or kinetic energy from the combustion gases 143 is extracted via one or more stages of HP turbine stator vanes and HP turbine rotor blades that are coupled to the HP shaft 122. This causes the HP shaft 122 to rotate, thereby supporting operation of the HP compressor 112 (self-sustaining cycle). In this way, the combustion gases 143 do work on the HP turbine 116. The combustion gases 143 are then routed into the LP turbine 118 and expanded through the LP turbine 118. Here, a second portion of the thermal energy or the kinetic energy is extracted from the combustion gases 143 via one or more stages of LP turbine stator vanes and LP turbine rotor blades that are coupled to the LP shaft 124. This causes the LP shaft 124 to rotate, thereby supporting operation of the LP compressor 110 (self-sustaining cycle) and rotation of the fan 126 via the gearbox assembly 135. In this way, the combustion gases 143 do work on the LP turbine 118.

The combustion gases 143 are subsequently routed through the jet exhaust nozzle section 120 of the turbo-engine 104 to provide propulsive thrust. Simultaneously, the bypass air 137 is routed through the bypass airflow passage 140 before being exhausted from a fan nozzle exhaust section of the engine 100, also providing propulsive thrust. The HP turbine 116, the LP turbine 118, and the jet exhaust nozzle section 120 at least partially define a hot gas path for routing the combustion gases 143 through the turbo-engine 104.

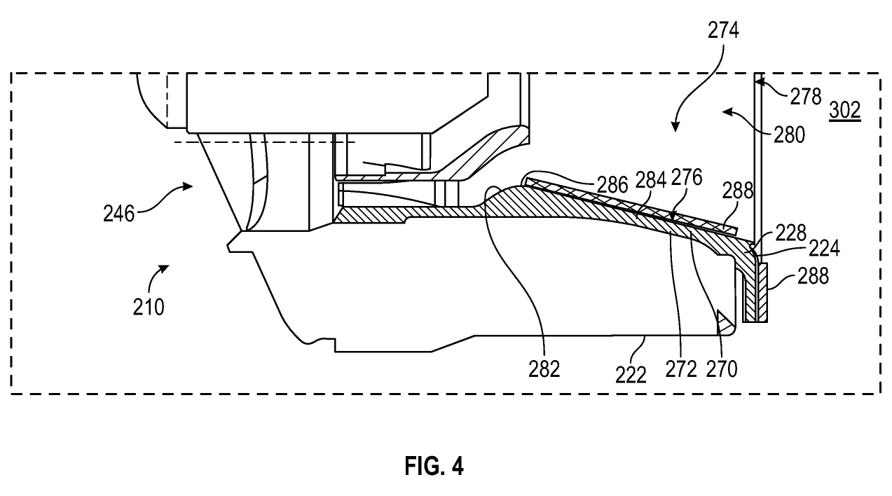

The engine 100 is operable with the fuel system 150 and receives a flow of fuel from the fuel system 150. The fuel system 150 includes a fuel delivery assembly 153 providing the fuel flow from the fuel tank 151 to the engine 100, and, more specifically, to a plurality of fuel injectors 200 that inject fuel into a combustion chamber 302 of a combustor 300 (see FIG. 4, discussed further below) of the combustion section 114.

The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within a combustion chamber 302 of the combustor 300.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 302 and combusted. Adjusting the fuel metering unit 157 changes the volume of fuel provided to the combustion chamber 302 and, thus, changes the amount of propulsive thrust produced by the engine 100 to propel the aircraft 20.

The engine 100 also includes various accessory systems to aid in the operation of the engine 100 and/or an aircraft that includes the engine 100. For example, the engine 100 may include a main lubrication system 162, a compressor cooling air (CCA) system 164, an active thermal clearance control (ATCC) system 166, and a generator lubrication system 168, each of which is depicted schematically in FIG. 2. The main lubrication system 162 is configured to provide a lubricant to, for example, various bearings and gear meshes in the compressor section, the turbine section, the HP spool 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/ heat removal for the electronic generator. The electronic generator may provide electrical power to, for example, a startup electrical motor for the engine 100 and/or various other electronic components of the engine 100 and/or an aircraft including the engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, in other embodiments, the gas turbine engine may have other suitable configurations, such as, direct drive configurations, fixed pitch fans, or other suitable numbers or arrangements of shafts, compressors, turbines, fans, etc. Further, although a particular engine 100 is depicted in FIG. 2, the catalytic coatings disclosed herein may be used more generally and/or with other engine embodiments. For example, in alternative embodiments, aspects of the present disclosure may be incorporated into, or otherwise utilized with any other type of engine, such as reciprocating engines. Additionally, in still other exemplary embodiments, the exemplary engine 100 may include or be operably connected to any other suitable accessory systems. Additionally, or alternatively, the exemplary engine 100 may not include or be operably connected to one or more of the accessory systems 162, 164, 166, and 168, discussed above.

FIG. 3 shows a combustor 300 of the combustion section 114 (FIG. 2) according to an embodiment of the present disclosure. FIG. 3 is a detail view showing detail 3 in FIG. 2. The combustor 300 is an annular combustor that includes a combustion chamber 302 defined between an inner liner 304 and an outer liner 306. Each of the inner liner 304 and outer liner 306 is annular about the longitudinal centerline axis 101 of the engine 100 (FIG. 2). The combustor 300 also includes a combustor case 308 that is also annular about the longitudinal centerline axis 101 of the engine 100. The combustor case 308 extends circumferentially around the inner liner 304 and the outer liner 306, and the inner liner 304 and outer liner 306 are located radially inward of the combustor case 308. The combustor 300 also includes a dome 310 mounted to a forward end of each of the inner liner 304 and the outer liner 306. The dome 310 defines an upstream (or forward end) of the combustion chamber 302.

A plurality of mixer assemblies 210 (only one is illustrated in FIG. 3) are spaced around the dome 310. The plurality of mixer assemblies 210 are circumferentially spaced about the longitudinal centerline axis 101 of the engine 100. In the embodiment shown in FIG. 3, each mixer assembly 210 is a twin annular premixing swirler (TAPS) that includes a main mixer 212 and a pilot mixer (not shown). The pilot mixer is supplied with fuel from the fuel injector 200 during the entire engine operating cycle, and the main mixer 212 is supplied with fuel from the fuel injector 200 only during increased power conditions of the engine operating cycle, such as take-off and climb, for example. The TAPS mixer assembly 210 is provided by way of example and the catalytic coating discussed herein may be applied to other mixer assembly designs and other combustor designs.

As noted above, the compressor section, including the HP compressor 112 (FIG. 2), pressurizes air, and the combustor 300 receives an annular stream of this pressurized air from a discharge outlet (compressor discharge outlet 216) of the HP compressor 112. This air may be referred to as compressor discharge pressure air. A portion of the compressor discharge air flows into the mixer assembly 210. Fuel is injected into the air in the mixer assembly 210 to mix with the air and to form a fuel-air mixture. The fuel-air mixture is provided to the combustion chamber 302 from the mixer assembly 210 for combustion. Ignition of the fuel-air mixture is accomplished by an igniter 312, and the resulting combustion gases flow in an axial direction toward and into an annular, first stage turbine nozzle 314. The first stage turbine nozzle 314 is defined by an annular flow channel that includes a plurality of radially extending, circularly-spaced nozzle vanes 316 that turn the gases so that they flow angularly and impinge upon the first stage turbine blades (not shown) of a first turbine (not shown) of the HP turbine 116 (FIG. 2).

The fuel injector 200 is fixed to the combustor case 308 by a nozzle mount. In this embodiment, the nozzle mount is a flange 202 that is integrally formed with a stem 204 of the fuel injector 200. The flange 202 is fixed to the combustor case 308 and sealed to the combustor case 308. The stem 204 includes a flow passage through which the hydrocarbon fuel flows, and the stem 204 extends radially inward from the flange 202. The fuel injector 200 also includes a fuel nozzle tip 220 through which fuel is injected into the combustion chamber 302 as part of the mixer assembly 210.

FIG. 4 shows the mixer assembly 210 of the combustor 300 shown in FIG. 3. FIG. 4 is a detail view showing detail 5 in FIG. 3, and, as FIG. 3 is a cross-sectional view, FIG. 4 is also a cross-sectional view of the mixer assembly 210. The fuel nozzle tip 220 (FIG. 3) includes a fuel nozzle body 222 and an aft heat shield 224 attached to the fuel nozzle body 222. The fuel nozzle body 222 may be mounted to, e.g., an inlet fairing. The inlet fairing is connected to or integral with the stem 204 (FIG. 3). The fuel nozzle body 222 may include, for example, a main fuel nozzle and a dual orifice pilot fuel injector tip having a primary pilot fuel orifice and a secondary pilot fuel orifice. The primary pilot fuel orifice and the secondary pilot fuel orifice may be substantially concentric with each other and substantially centered in an annular pilot inlet 246. The main fuel nozzle surrounds the pilot inlet 246, and the pilot inlet 246 is located between the main fuel nozzle and the dual orifice pilot fuel injector tip. In this embodiment, the fuel nozzle tip 220 (see FIG. 3) is circular about an axis extending through the center of the primary pilot fuel orifice. In the discussion below, various features of the fuel nozzle tip 220 may be discussed relative to this axis. Fuel is provided through the stem 204 to the main fuel nozzle. The main fuel nozzle can inject fuel in a radially outward direction through a circular array of main fuel injection orifices formed on an outer surface of the fuel nozzle body 222. Fuel is also provided through the stem 204 to the primary pilot fuel orifice and the secondary pilot fuel orifice. The pilot mixer is supported by an annular pilot housing 270.

The pilot housing 270 includes a conical wall section 272 circumscribing a conical pilot mixing chamber 274 that is in flow communication with, and downstream from, the pilot mixer, and, more specifically, the outlet. The pilot mixing chamber 274 is also fluidly connected to the primary pilot fuel orifice and the secondary pilot fuel orifice, and downstream of the primary pilot fuel orifice and the secondary pilot fuel orifice. The pilot mixing chamber 274 is a passage of the fuel injector 200 and, more specifically, the fuel nozzle tip 220. As the fuel nozzle tip 220 is also a portion of the mixer assembly 210, the pilot mixing chamber 274 also is a passage of the mixer assembly 210.

The conical wall section 272 of the pilot housing 270 is thus a passage wall that includes a passage wall surface 276 facing the pilot mixing chamber 274 (passage). In this embodiment, the conical wall section 272 is part of a second venturi 280 formed by the pilot housing 270. The second venturi 280 includes a converging section 282, a diverging section 284, and a throat 286 between the converging section 282 and the diverging section 284. The diverging section 284 is provided by the conical wall section 272, which extends downstream from the throat 286 and continues with exposed surfaces 228 of the aft heat shield 224. The exposed surfaces 228 of this embodiment form a conical wall section of the aft heat shield 224 that is coplanar with the wall surface 276 of the conical wall section 272. Diverging section 284 has an upstream end, which, in this embodiment, is the throat 286 and a downstream end, which, in this embodiment, is an outlet 278 of the pilot mixing chamber 274. As can be seen in FIG. 4, the cross-sectional area of the second venturi 280 at the outlet 278 (the downstream end) is greater than the cross-sectional area of the second venturi 280 at the throat 286 (the upstream end).

Air flows through the outer pilot swirler through the converging section 282 toward the throat 286. This air is mixed with the fuel-air mixture from the outlet and moves through the throat 286 to the diverging section 284 and the aft heat shield 224. The pilot mixing chamber 274 and, more specifically, the wall surface 276 of the conical wall section 272 are exposed to hydrocarbon fuel as the fuel-air mixture flows through the pilot mixing chamber 274, through the outlet 278 of the pilot mixing chamber 274, and into the combustion chamber 302. Being adjacent to the combustion chamber 302 and adjacent to the primary combustion zone, the fuel, the conical wall section 272, and the aft heat shield 224 are exposed to high temperatures. For example, the conical wall section 272 and the aft heat shield 224 may be at temperatures from three hundred degrees Celsius to six hundred degrees Celsius and from six hundred degrees Celsius to one thousand four hundred degrees Celsius, respectively.

The pilot housing 270 and the aft heat shield 224 are made from materials suitable for use in these high temperature environments including, for example, stainless steel, corrosion-resistant alloys of nickel and chromium, and high-strength nickel-base alloys. The pilot housing 270 and the aft heat shield 224 may thus be formed from a metal alloy chosen from the group consisting of iron-based alloys, nickel-based alloys, cobalt-based alloys, and chromium-based alloys. Exposed surfaces of these materials at these temperatures, and, more particularly, the wall surface 276 may thus be susceptible to a significant build-up of coke and/or partially burned fuel deposits. The coke forming on such materials may be strongly bound to these metallic components of the fuel nozzle tip 220 leading to the formation of a thick layer of coke with large particles. As noted above, coke can build up in considerable thickness on these surfaces and large pieces of coke can shed off, becoming internal domestic objects that can cause significant damage to components downstream of the fuel nozzle (hot gas path components).

To prevent the build-up of coke and the issues discussed above, at least a portion of the surfaces of the second venturi 280, including, for example, the wall surface 276 and the aft heat shield 224 may be coated with a catalytic coating 288 to inhibit coke deposition and build-up. As noted above, the pilot mixing chamber 274 is a passage, and, in embodiments discussed herein, a portion of the wall of the passage is a coated passage wall that is coated with the catalytic coating 288. The coated passage wall is located downstream of the fuel injection port (the primary pilot fuel orifice and the secondary pilot fuel orifice, in this embodiment). As noted above, air flows through the pilot mixing chamber 274 (passage) and is introduced by an air inlet. In these embodiments, the air inlet is upstream of the coated passage wall. More specifically, air is introduced into the pilot mixing chamber 274 (passage) by the pilot inlet 246, through the inner pilot swirler and the outer pilot swirler. The air flowing through the inner pilot swirler is also introduced to the pilot mixing chamber 274 via outlet 278.

Exposed surfaces of the underlying (base) material of the pilot housing 270, and, more specifically, the conical wall section 272 or the aft heat shield 224, promote the formation of thick, large grains of coke, and the catalytic coating 288 of this embodiment is applied as a continuous layer on the wall surface 276 to avoid discontinuities that would expose the base material. Depending on the application region, the thickness of the catalytic coating 288 can be suitably determined to account for, for example, the coke buildup rate, catalyst wear rate, etc. The catalytic coating 288 may have a thickness of, for example, less than two hundred microns, such as less than one hundred microns, less than ten microns, less than five microns, or less than two microns. In some embodiments, the thickness of the catalytic coating 288 may be from one micron to two hundred microns. In other embodiments, the catalytic coating 288 may have a thickness of, for example, less than three hundred nanometers such as less than one hundred nanometers. In some embodiments, the thickness of the catalytic coating 288 may be from twenty nanometers to three hundred nanometers. In some embodiments, the thickness of the catalytic coating 288 may be from three hundred nanometers to ten microns. Typically, thicknesses can range from 0.5 mil to four mils. Higher thicknesses can help if the layer is being continuously eroded/corroded during operation. Thicker layers may lead to more instability issues with respect to coating delamination/spallation because of cycling thermal stresses. The thickness can be chosen to ensure the coating remains in place as long as possible and prevent spalling as well as account for loss by erosion/corrosion.

The catalytic coating 288 may have a smooth surface finish having a surface roughness Ra ranging from 0.01 microns to 0.4 microns. A smooth surface finish may also help to prevent coke from sticking to the second venturi 280. In some embodiments, the catalytic coating 288 may have a surface finish having a surface roughness Ra from five microns to ten microns when deposited using, for example, an air plasma spray and, in other embodiments, from 0.5 micron to 1.5 microns when deposited using, for example, electron beam physical vapor deposition. Other techniques of catalytic coating deposition may include slurry spray, suspension plasma spray, and solution precursor plasma spray, all of which may have a surface finish having a surface roughness Ra ranging from 0.5 micron to ten microns.

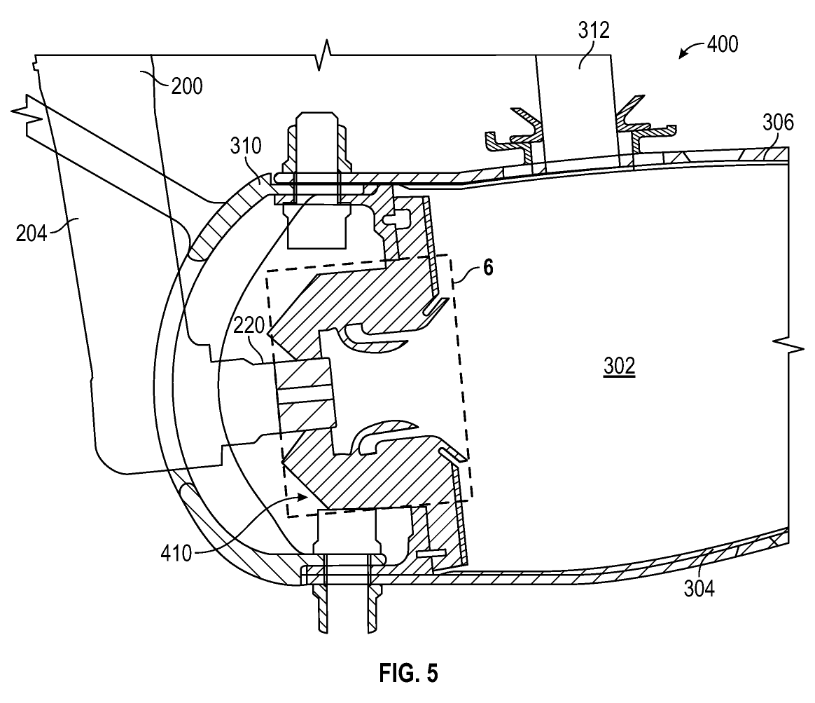

In the preceding discussion, the combustor 300 and the mixer assembly 210 were configured to use a twin annular premixing swirler (TAPS), but the catalytic coating 288 discussed herein may be applied to other mixer assembly designs and other combustor designs. Another example of a combustor 400 is shown in FIG. 5.

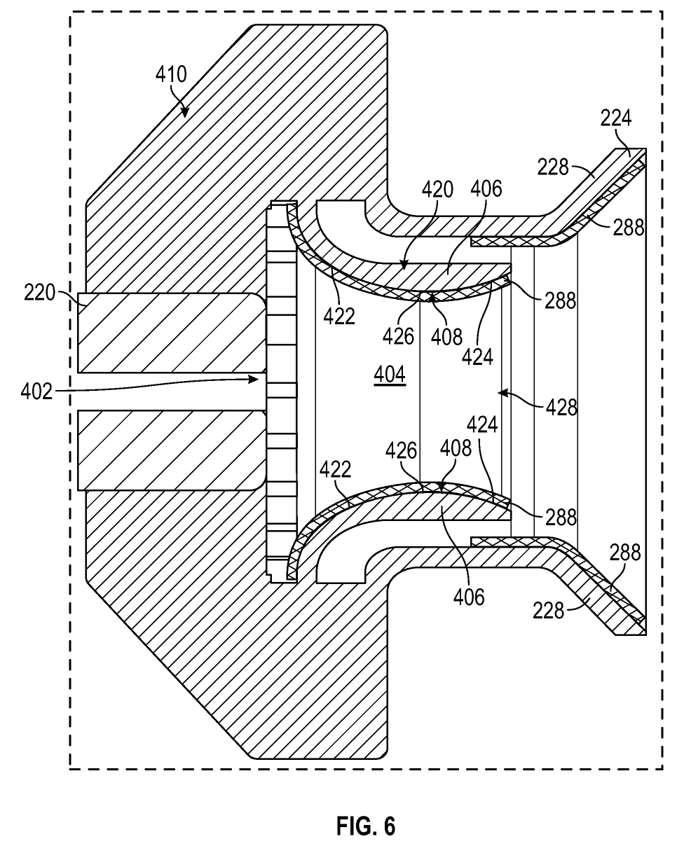

FIG. 5 is a cross-sectional view of the combustor 400 showing a rich burn combustor design. FIG. 6 shows a mixer assembly 410 of the combustor 400 shown in FIG. 5. FIG. 6 is a detail view showing detail 6 in FIG. 5, and, as FIG. 5 is a cross-sectional view, FIG. 6 is also a cross-sectional view of the mixer assembly 410. The combustor 400 and the mixer assembly 410 of this embodiment include the same or similar components as the combustor 300 and the mixer assembly 210 discussed above. Components in this embodiment that are the same or similar to those discussed above are identified with the same reference numeral and a detailed description of these components is omitted.

The combustor 400 of this embodiment shows a rich burn combustor. A plurality of mixer assemblies 410 (only one is illustrated) are spaced around the dome 310. Fuel is injected into the mixer assembly 410 by a fuel injection port 402. The fuel injection port 402 injects fuel in a generally downstream direction and into the compressed air flowing through a first swirler (not shown). The fuel is injected into a mixing chamber 404 that mixes the fuel with the compressed air to form a fuel-air mixture. As with the pilot mixing chamber 274 discussed above, the mixing chamber 404 of this embodiment is a passage of the fuel injector 200 with a wall section 406 that includes a passage wall surface 408 facing the mixing chamber 404 (passage). In this embodiment, the wall section 406 is part of a venturi 420 that includes a converging section 422, a diverging section 424, and a throat 426 between the converging section 422 and the diverging section 424. In this embodiment, the catalytic coating 288 is formed on the surfaces of the venturi 420. The fuel-air mixture exits through an outlet 428 of the mixing chamber 404 and is combined with air flowing through a second swirler (not shown) at a position upstream of the exposed surfaces 228 of the aft heat shield 224. In this embodiment, the catalytic coating 288 is also formed on the exposed surface 228 of the aft heat shield 224.

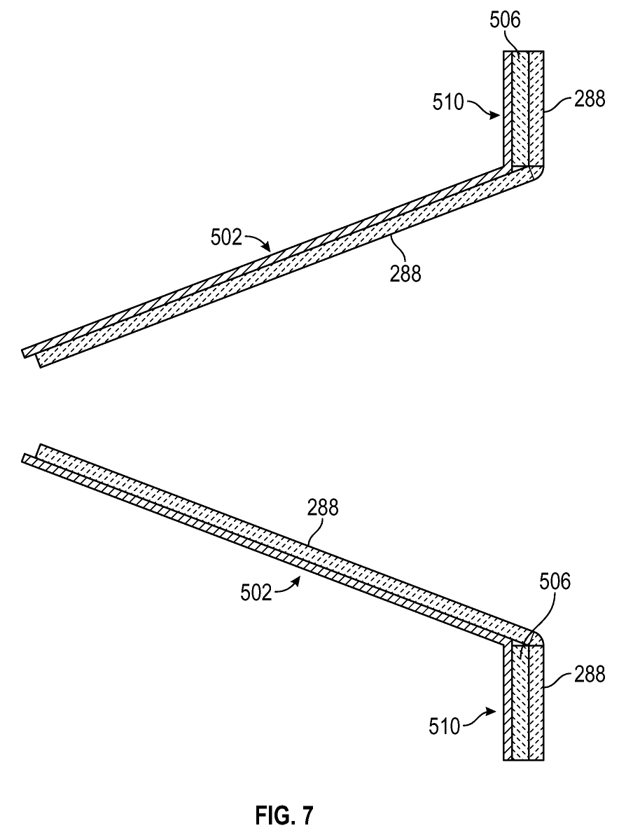

As discussed above, the catalytic coating 288 can be applied to a venturi component (e.g., the venturi 280 or the venturi 420). For example, the catalytic coating 288 can be applied directly to a surface of a venturi wall 502, as depicted in FIG. 7. Additionally, or alternatively, the catalytic coating 288 can be applied to the surface of the TBC 506, which exists on the surface of the AHS 510. The description of such components above applies here.

The preceding discussion is by way of example only and the catalytic coating may be applied to any substrate such as a metal substrate, a ceramic substrate, a metal substrate coated with a ceramic layer, or a ceramic substrate coated with a metal layer.

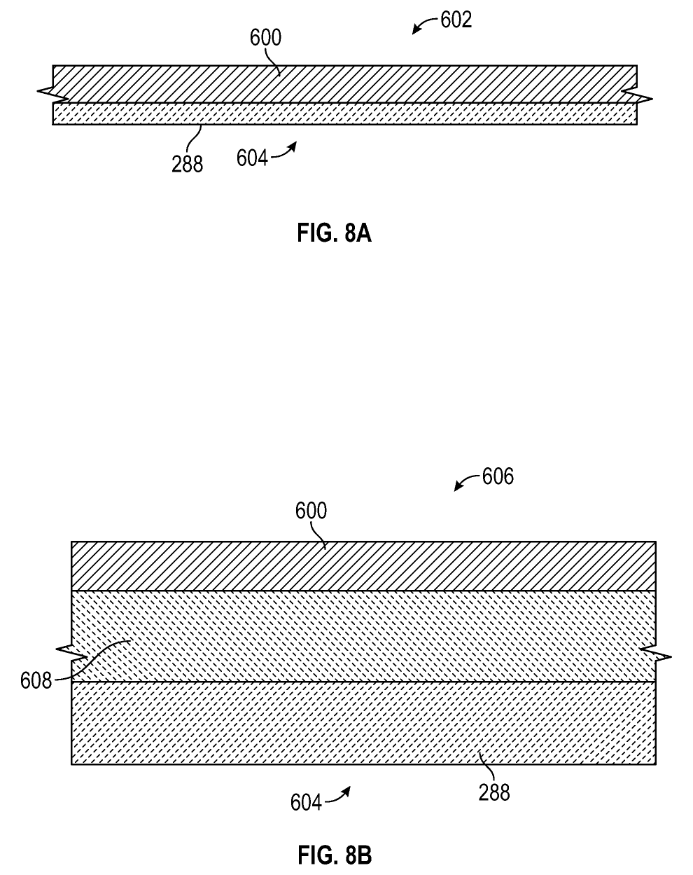

FIG. 8A depicts a catalytic coating 288 on a generic substrate 600. The generic substrate 600 may be a metal substrate, a ceramic substrate, a metal substrate coated with a ceramic layer, or a ceramic substrate coated with a metal layer. The generic substrate 600 may be a portion of a component 602 such as a component that is positioned or otherwise arranged to come into contact with, for example, a hydrocarbon fluid, such as fuel, oil, and the like, as discussed above, and the catalytic coating 288 may be applied to surface of the substrate facing the hydrocarbon fluid, such as a surface facing or otherwise defining a passage 604 for the hydrocarbon fluid to flow therethrough.

FIG. 8B also depicts the catalytic coating 288 on the generic substrate 600. A component 606 depicted in FIG. 8B is similar to the component 602 depicted in FIG. 8A. In some applications, the generic substrate 600 may be a metal and may have a ceramic coating 608 (such as a thermal barrier coating (TBC)) on the metal substrate. As discussed further herein, the catalytic coating 288 may be applied as a coating on top of the TBC, as depicted in FIG. 8A, or be integrated within the TBC. Example materials for TBCs include yttria-stabilized zirconia (YSZ such as 8 YSZ, 20 YSZ, 55 YSZ), La-Gd-Zirconate, La-Yb-Zirconate, La-Gd-Yb-Zirconate, rare-earth-Ta-Zirconate, rare-earth-Nb-Zirconate, and (ZrO₂)_{(1-q)}(Y₂O₃)_{q} wherein q ranges from 0.04 to 0.5. The metal substrates may include, for example, iron-based alloys, nickel-based alloys, cobalt-based alloys, alloys containing cobalt and chromium, alloys containing platinum and aluminum, alloys containing nickel and aluminum, or alloys containing nickel, chromium, aluminum, and yttrium.

The inventors unexpectedly discovered that the durability of the catalytic coating can be improved by controlling the architecture of the catalytic coating. For example, the inventors discovered that catalytic coatings (that include a first layer, a second layer, and a third layer where the second layer has a greater volume percent porosity than each of the first layer and the third layer) had surprisingly enhanced durability as compared to similar coatings without this architecture. For example, as discussed in the working examples below, the inventors found that a coated component (having the three-layer architecture) had a coating mass loss more than seven weight percent when exposed to a jet of hot air having a temperature of one thousand one hundred degrees Fahrenheit and a velocity of one hundred four liters per minute for one hour whereas a coated component (having the three-layer architecture) had a less than two weight percentage mass loss when subjected to the same test conditions.

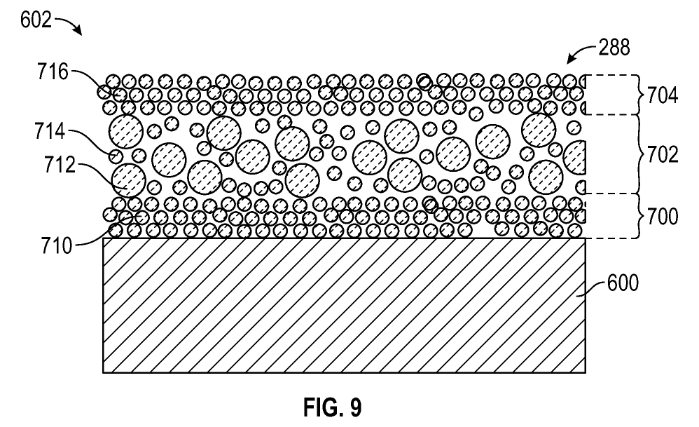

FIG. 9 depicts a cross-sectional view of the component 602 having the catalytic coating 288 on the substrate 600. The catalytic coating 288 has a plurality of layers including a first layer 700, a second layer 702, and a third layer 704. As depicted in FIG. 9, the second layer 702 may be a middle layer located between the first layer 700 and the third layer 704. The third layer 704 is a surface layer of the catalytic coating 288 defining the passage 604 and directly exposed to the fluid flowing therethrough. The first layer 700 is a bottom layer adjacent to the substrate 600, and, in the catalytic coating 288 depicted in FIG. 9, the first layer 700 is directly adjacent to the substrate 600 and may be used to bond or otherwise attach the catalytic coating 288 to the substrate 600. As depicted in FIG. 9, the first layer is in contact with the substrate, the second layer is in contact with the first layer, and the third layer is in contact with the second layer.

Each of the layers of the plurality of layers (i.e., the first layer 700, the second layer 702, and the third layer 704) includes a ceramic material and a noble metal. More specifically, the first layer 700 has a first ceramic material and a first noble metal, the second layer 702 has a second ceramic material and a second noble metal, and the third layer 704 has a third ceramic material and a third noble metal.

The first layer 700 includes a plurality of grains 710 and a volume percent porosity (e.g., ranging from ten percent to thirty percent). In some embodiments, the plurality of grains 710 of the first layer 700 have an average diameter ranging from 0.5 micron to one micron. The average diameter may be chosen, for example, to achieve a desired microstructure for improved catalytic performance (e.g., by increasing surface area) or durability (adhesion, cohesion and compliance), or both. In the first layer 700, the average diameter may be chosen, for example, to achieve good adhesion and cohesion by, e.g., increasing contact points with the substrate. Similarly, the third layer 704 has a plurality of grains 716 and a volume percent porosity (e.g., ranging from five percent to thirty percent). In some embodiments, the plurality of grains 716 of the third layer 704 have an average diameter ranging from 0.5 micron to two microns. In the third layer 704, the average diameter may be chosen to achieve good catalytic performance and improve cohesion between grains for durability against shear forces of flowing medium. The second layer 702 also has a plurality of grains, but the grain size of the plurality of grains of the second layer 702 is a multimodal (e.g., bimodal) distribution with a plurality of first grains 712 having a first mode diameter and a plurality of second grains 714 having a second mode diameter. The second mode diameter is greater than the first mode diameter, and the second mode diameter may be greater than the average diameter of the grains in the first layer 700, larger than the average diameter of the grains in the third layer 704, or both. The first mode diameter may range from 0.5 micron to two microns, and the second mode diameter may range from four microns to twenty microns. The second mode diameter may thus be at least two microns greater than the first mode diameter, such as at least two microns greater than the first mode diameter and less than 100 microns greater than the first mode diameter. In the second layer 702, the first mode diameter and the second mode diameter may be chosen to achieve good compliance and durability or the layer. The second layer 702 may have a volume percent porosity ranging from twenty percent to sixty percent. The volume percent porosity of the second layer 702 may be greater than the volume percent porosity of the first layer and/or the volume percent porosity of the third layer. With the catalytic coating 288 structured as discussed herein, the catalytic coating 288 has a surprisingly enhanced durability as compared to coatings that lack this architecture.

Depending on the application, the thickness of the catalytic coating can be suitably determined to account for, for example, the coke buildup rate, catalytic coating wear rate, etc. For example, the catalytic coating may have a thickness ranging from twenty-five microns to eighty microns, ranging from thirty microns to seventy-five microns, ranging from forty microns to seventy microns, or ranging from fifty microns to sixty microns. In some embodiments, a thin coating may be used having good durability and performance.

Similarly, the thickness of each layer can be controlled to adjust the durability and/or catalytic performance of the catalytic coating. For example, the first layer can have a thickness ranging from 2.5 microns to fifteen microns, the second layer can have a thickness ranging from twenty-five microns to fifty-one microns, and the third layer can have a thickness ranging from 2.5 microns to fifteen microns.

The catalytic coating may also include a binder, such as silica, to improve the cohesion of the coating.

The catalytic coating can be applied to a substrate by using various techniques. For example, the catalytic coating can be applied to a substrate by spraying particles of the first ceramic material and the first noble metal on the substrate such that the particles of the first ceramic material and the first noble metal have an average particle diameter ranging from 0.5 micron to one micron, spraying particles of the second ceramic material and the second noble metal such that the particles of the second ceramic material and the second noble metal have a first plurality of particles having an average particle diameter ranging from 0.5 micron to two microns and a second plurality of particles having an average particle diameter ranging from four microns to twenty microns, spraying particles of the third ceramic material and the third noble metal such that the particles of the third ceramic material and the third noble metal have an average particle diameter ranging from 0.5 micron to two microns, and sintering the particles to form the coated component.

The sintering step can occur at various temperatures and for various durations. For example, the sintering step can be performed at a temperature ranging from one thousand five hundred degrees Fahrenheit to two thousand degrees Fahrenheit. The sintering step can be performed for a duration ranging from ten minutes to five hours such as, for example, from thirty minutes to ninety minutes. In some embodiments, the catalytic coating is flash sintered. For example, in some embodiments, the catalytic coating is flash sintered by heating one side of the coating and cooling the opposite side of the coating. In some embodiments, the catalytic coating is flash sintered by heating one side of the coating for one to ten heating cycles.

Without wishing to be bound by theory, the sintering step is believed to fuse the particles of the first ceramic material and the first noble metal to form the plurality of grains having the average diameter ranging from 0.5 micron to one micron in the first layer of the catalytic coating, the sintering step fuses the particles of the second ceramic material and the second noble metal to form the plurality of grains having the bimodal distribution with the first mode diameter ranging from 0.5 micron to two microns and the second mode diameter ranging from four microns to twenty microns in the second layer of the catalytic coating, and the sintering step fuses the particles of the third ceramic material and the third noble metal to form the plurality of grains having the average diameter ranging from 0.5 micron to two microns in the third layer of the catalytic coating. In some embodiments, the sintering step involves heating the coating from the top layer so that the top layer reaches a higher temperature ranging from one thousand five hundred degrees Fahrenheit to two thousand degrees Fahrenheit. The top layer may be well sintered, resulting in neck formation among the particles, thus increasing coating durability against the shear forces exerted by a flowing fluid medium and providing mechanical durability without losing interconnected open porosity.

It was surprisingly found that the average grain size in each of the first layer 700, the second layer 702, and the third layer 704 impacts the durability of the coating. The average grain size in each of the first layer, the second layer, and the third layer may be independently controlled by, for example, adjusting the particle sizes of the ceramic material and/or the noble metal used to form each respective layer. Additionally, and/or alternatively, average grain size in each of the first layer, the second layer, and the third layer may be independently controlled by, for example, adjusting the chemical composition and/or thermal processing conditions used to form each respective layer. In some embodiments, the first layer has plurality of grains having an average diameter ranging from 0.5 micron to one micron. In some embodiments, the second layer has a plurality of grains having a bimodal distribution with a first mode diameter ranging from 0.5 micron to two microns and a second mode diameter ranging from four microns to twenty microns. In some embodiments, the third layer has a plurality of grains having an average diameter ranging from 0.5 micron to two microns.

It was surprisingly found that the volume percent porosity in each of the first layer 700, the second layer 702, and the third layer 704 impacts the durability of the coating. Without wishing to be bound by theory, it is believed that the volume percent porosity impacts the strain tolerance of the coating when the coating is subjected to, e.g., mechanical and/or thermal induced strain. In some embodiments, the first layer has a volume percent porosity ranging from ten percent to thirty percent. In some embodiments, the second layer has a volume percent porosity ranging from twenty percent to sixty percent. In some embodiments, the third layer has a volume percent porosity ranging from five percent to thirty percent. In some embodiments, the coating has open surface pores connected to the layers underneath. Open pores at the top layer may allow the reactants (e.g., air and coke) to access more catalytic sites beneath the top layer, thus increasing the coke oxidation kinetics. The porosity of the layers may be interconnected to allow the reactants (e.g., air and coke) to access more catalytic sites.

The architecture of the coating is believed to provide enhanced coating durability irrespective of the chemical composition of the first ceramic material, the first noble metal, the second ceramic material, the second noble metal, the third ceramic material, and the third noble metal. In some embodiments, the first ceramic material, the second ceramic material, and the third ceramic material each has a different chemical composition. In some embodiments, the first ceramic material, the second ceramic material, and the third ceramic material each has the same chemical composition. In some embodiments, the first noble metal, the second noble metal, and the third noble metal are each independently chosen from rhenium, ruthenium, rhodium, palladium, silver, osmium, iridium, platinum, and gold. For example, in some embodiments, the first noble metal, the second noble metal, and the third noble metal are each a different noble metal. As another example, in some embodiments, the first noble metal, the second noble metal, and the third noble metal are the same noble metal.

In some embodiments, each of the first ceramic material, the second ceramic material, and the third ceramic material may be independently chosen from metal oxides of formula (I) AₓE_{y}L_{z}MOᵤ. In formula (I), A is one or more alkaline earth elements chosen from, magnesium, calcium, strontium, and barium; x ranges from zero to one, E is one or more alkali metals chosen from lithium, sodium, potassium, y ranges from zero to one, L is one or more lanthanide elements chosen from lanthanum, cerium, praseodymium, neodymium, samarium, europium, gadolinium, terbium, dysprosium, ytterbium, and lutetium, z ranges from zero to one, M is one or more elements chosen from titanium, vanadium, chromium, manganese, iron, cobalt, nickel, copper, zinc, yttrium, zirconium, niobium, molybdenum, ruthenium, rhodium, palladium, silver, tantalum, tungsten, rhenium, iridium, platinum, gold, bismuth, O is oxygen, and u ranges from 0.95 to six.

Different metal oxides of formula (I) may have different reactivities and/or selectivity’s for catalyzing reactions that degrade coke. In some embodiments, u ranges from 0.95 to three. In some embodiments, A is barium or strontium. In some embodiments, E is lithium, sodium, or potassium. In some embodiments, L is lanthanum, cerium, praseodymium, neodymium, samarium, gadolinium, or ytterbium. In some embodiments, and M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium. In some embodiments, the metal oxide is one or more composition chosen from Co₃O₄, NiₓCo₃₋ₓO₄, FeₓCo₃₋ₓO₄,CuₓCo₃₋ₓO₄,CrₓCo₃₋ₓO₄,Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1}_{-(x+y+z)]}CoO₃,LnₓLi_{y}Sr_{z}Ba_{[1}_{-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O_{3,} Fe₃O₄, ZnFe₂O₄, BiₓSn₁₋ₓOᵤ, InₓSn_{y}O_{z}, Bi₂O₃-Co₃O₄, and CeO₂.

As discussed above, the catalytic coating may be effective for coke abatement and may be used in various methods, for example, for oxidizing coke. In some embodiments, a method of oxidizing coke includes contacting the coke with the catalytic coating at a temperature ranging from three hundred degrees Fahrenheit to one thousand one hundred degrees Fahrenheit such that the coke is selectively oxidized by the catalytic coating in the presence of a hydrocarbon fuel.

### EXAMPLES

Specific embodiments will be demonstrated by reference to the following examples. These examples are disclosed solely by way of illustrating the present disclosure and should not be taken in any way to limit the scope of the present disclosure.

### Example one: catalytic coatings were made according to the following procedure.

The first layer (bottom portion) was deposited on a metal substrate (Inconel/ NiAl) by slurry spray coating using fine particles (d₅₀ of 0.5 to one micron) with a relatively high solids loading (fifty percent to seventy percent). Organic solvents (butanol/ethanol) were used to make the slurry with one to five wt.% of silica-based binder. During the coating process, the thickness of the layer was controlled by the number of passes with the spray coater and the thickness was maintained within a range of 0.1 to 0.5 mils. The second layer (middle portion) was deposited by the same method but by using a bimodal particle size distribution (d₅₀ between 0.5 to two microns and four to twenty microns). The volume fraction of finer particles was varied between ten percent to fifty percent to reach the desired microstructure. The third layer (top portion) was spray coated using finer particles (d₅₀ of 0.5 to two micron). A short time interval (one to three minutes) was given in between two different layers to dry the coating at room temperature. The entire coating was dried at room temperature for two hours and cured at nine hundred degrees Fahrenheit for two hours. Finally, the coated substrate was sintered from the top by a flash sintering technique to densify the system while maintaining interconnected porosity. The temperature of the top layer during flash sintering was maintained between one thousand five hundred degrees Fahrenheit to two thousand degrees Fahrenheit, depending on the metal substrate.

Samples were mounted in epoxy and cross-sectioned to examine the microstructure and the interface between the coating and the substrate under a scanning electron microscope (SEM). The ceramic material and noble metal are ninety percent ceria with ten percent silver in each layer and the substrate was a platinum coated nickel alloy.

### Example two: air impingement test.

Samples were mounted on a holder and placed in the furnace perpendicular to the hot-gas nozzle path. The test was carried out at one thousand one hundred degrees Fahrenheit for one hour. The velocity of the hot air was maintained at one hundred and four liters per minute. The sample weight and optical image were taken before and after the experiment.

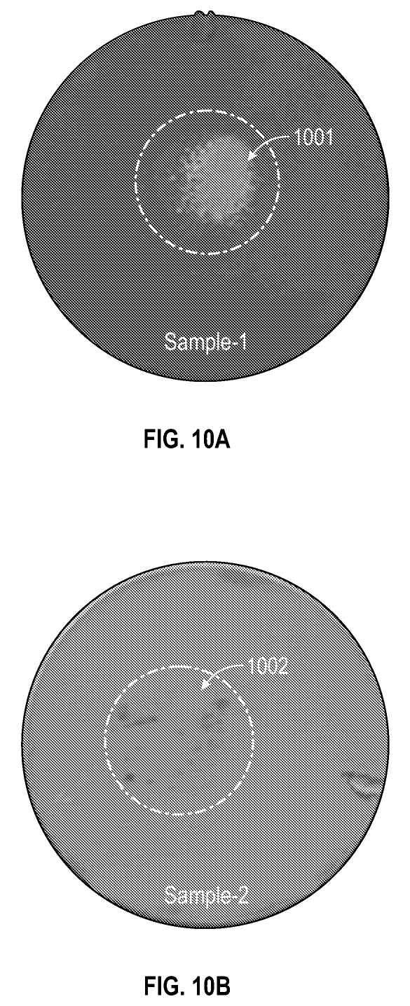

FIG. 10A depicts a control sample, after the air impingement test, showing an ablated region 1001. The control sample was made from particles of ninety percent ceria with ten percent silver that did not have the three-layer coating architecture. This sample had a 7.3 percent mass loss during the air impingement test.

FIG. 10B depicts a sample, after the air impingement test, showing an ablated region 1002. The sample was made from particles of ninety percent ceria with ten percent silver that did have the three-layer coating architecture and was cured by flash sintering at one thousand seven hundred degrees Fahrenheit. This sample had a 1.5 percent mass loss during the air impingement test.

### Example Three: thermal cycling test.

Furnace cycling tests were conducted in bottom-loading thermal cycling furnaces (CM Furnaces Inc.). The thirty minutes cycles consisted of a five-minute heat-up to the cycle temperature, followed by a dwell for twenty minutes at the maximum temperature of one thousand one hundred degrees Fahrenheit. The final step was a five-minute forced-air cool to room temperature. A total of one hundred cycles were carried out to assess the coating durability.

As discussed above the three layer architecture surprisingly improves the durability of the catalytic coating as compared to a coating having the same composition but different architecture and not subjected to flash sintering.

Further aspects of the present disclosure are provided by the subject matter of the following clauses.

A catalytic coating including a first layer having a first ceramic material and a first noble metal, wherein the first layer has a volume percent porosity, a second layer having a second ceramic material and a second noble metal, wherein the second layer has a plurality of grains having a multimodal size distribution, and the second layer has a volume percent porosity that is greater than the volume percent porosity of the first layer, and a third layer having a third ceramic material and a third noble metal, wherein the third layer has a volume percent porosity that is less than the volume percent porosity of the second layer.

The catalytic coating of the preceding clause, such that the first layer has a plurality of grains having an average diameter ranging from 0.5 micron to one micron and the volume percent porosity of the first layer ranges from ten percent to thirty percent, the second layer has a bimodal grain size distribution with a first mode diameter ranging from 0.5 micron to two microns and a second mode diameter ranging from four microns to twenty microns, and the volume percent porosity of the second layer ranges from twenty percent to sixty percent, and the third layer has a plurality of grains having an average diameter ranging from 0.5 micron to two microns and the volume percent porosity of the third layer ranges from five percent to thirty percent.

The catalytic coating of any of the preceding clauses, such that the first ceramic material, the second ceramic material, and the third ceramic material have the same chemical composition.

The catalytic coating of any of the preceding clauses, such that the first layer has a thickness ranging from 2.5 microns to fifteen microns.

The catalytic coating of any of the preceding clauses, such that the second layer has a thickness ranging from twenty-five microns to fifty microns.

The catalytic coating of any of the preceding clauses, such that the third layer has a thickness ranging from 2.5 microns to fifteen microns.

The catalytic coating of any of the preceding clauses, such that each layer includes a binder.

The catalytic coating of any of the preceding clauses, such that the binder includes silica.

A coated component including the catalytic coating of any of the preceding clauses coated on a substrate.

The coated component of the preceding clause, such that the coated component has a coating mass loss of less than seven weight percent when exposed to a jet of hot air having a temperature of one thousand one hundred degrees Fahrenheit and a velocity of one hundred and four liters per minute for one hour.

The coated component of any of the preceding clauses, such that the first layer contacts the substrate, the second layer contacts the first layer, and the third layer contacts the second layer.

The coated component of any of the preceding clauses, such that the coated component is an aircraft component.

The coated component of any of the preceding clauses, such that the coated component is a gas turbine engine component.

The coated component of any of the preceding clauses, such that the coated component is a venturi surface, a fuel nozzle, a fuel circuit component, or an oil lube circuit component.

The coated component of any of the preceding clauses, such that the substrate is a metal substrate, a ceramic substrate, a metal substrate coated with a ceramic layer, or a ceramic substrate coated with a metal layer.

The coated component of any of the preceding clauses, such that the substrate is the metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

The coated component of any of the preceding clauses, such that the substrate is the metal substrate coated with the ceramic layer and the ceramic layer is a thermal barrier coating.

A method of oxidizing coke, the method including contacting the coke with the catalytic coating of any of the preceding clauses at a temperature ranging from three hundred degrees Fahrenheit to one thousand one hundred degrees Fahrenheit.

A method of making the coated component of any of the preceding clauses, the method including spraying particles of the first ceramic material and the first noble metal on the substrate, wherein the particles of the first ceramic material and the first noble metal have an average particle diameter ranging from 0.5 micron to one micron, spraying particles of the second ceramic material and the second noble metal, wherein the particles of the second ceramic material and the second noble metal have a first plurality of particles having an average particle diameter ranging from 0.5 micron to one micron and a second plurality of particles having an average particle diameter ranging from four microns to twenty microns, spraying particles of the third ceramic material and the third noble metal, wherein the particles of the third ceramic material and the third noble metal have an average particle diameter ranging from 0.5 micron to two microns, and sintering at least some of the particles of the third ceramic material and the third noble metal at a temperature ranging from one thousand five hundred degrees Fahrenheit to two thousand degrees Fahrenheit.

The method of the preceding clause, such that the sintering fuses the particles of the first ceramic material and the first noble metal to form the plurality of grains having the average diameter ranging from 0.5 micron to one micron in the first layer of the catalytic coating, the sintering fuses the particles of the second ceramic material and the second noble metal to form the plurality of grains having the bimodal distribution with the first mode diameter ranging from 0.5 micron to two microns and the second mode diameter ranging from four microns to twenty microns in the second layer of the catalytic coating, and the sintering fuses the particles of the third ceramic material and the third noble metal to form the plurality of grains having the average diameter ranging from 0.5 micron to two microns in the third layer of the catalytic coating.

A coated component including a substrate and a catalytic coating, the catalytic coating has a first layer in contact with the substrate, the first layer including a first ceramic material and a first noble metal, wherein the first layer has a volume percent porosity, a second layer in contact with the first layer, the second layer including a second ceramic material and a second noble metal, wherein the second layer has a plurality of grains having a multimodal size distribution, and the second layer has a volume percent porosity that is greater than the volume percent porosity of the first layer, and a third layer in contact with the second layer, the third layer including a third ceramic material and a third noble metal, wherein the third layer has a volume percent porosity that is less than the volume percent porosity of the second layer.

The coated component of the preceding clause, such that the first layer has a plurality of grains having an average diameter ranging from 0.5 micron to one micron and the volume percent porosity of the first layer ranges from ten percent to thirty percent, the second layer has a bimodal grain size distribution with a first mode diameter ranging from 0.5 micron to two microns and a second mode diameter ranging from four microns to twenty microns, and the volume percent porosity of the second layer ranges from twenty percent to sixty percent, and the third layer has a plurality of grains having an average diameter ranging from 0.5 micron to two microns and the volume percent porosity of the third layer ranges from five percent to thirty percent.

The coated component of any of the preceding clauses, such that the first ceramic material, the second ceramic material, and the third ceramic material have the same chemical composition.

The coated component of any of the preceding clauses, such that the first layer has a thickness ranging from 2.5 microns to fifteen microns.

The coated component of any of the preceding clauses, such that the second layer has a thickness ranging from twenty-five microns to fifty microns.

The coated component of any of the preceding clauses, such that the third layer has a thickness ranging from 2.5 microns to fifteen microns.

The coated component of any of the preceding clauses, such that each layer includes a binder.

The coated component of any of the preceding clauses, such that each layer includes a binder including silica.

The coated component of any of the preceding clauses, such that the coated component has a coating mass loss of less than seven weight percent when exposed to a jet of hot air having a temperature of one thousand one hundred degrees Fahrenheit and a velocity of one hundred and four liters per minute for one hour.

The coated component of any of the preceding clauses, such that the first ceramic material, the second ceramic material, and the third ceramic material are each independently chosen from metal oxides of formula (I) AxEyLzMOu where A is one or more alkaline earth elements chosen from, magnesium, calcium, strontium, and barium; x ranges from zero to one, E is one or more alkali metals chosen from lithium, sodium, potassium, y ranges from zero to one, L is one or more lanthanide elements chosen from lanthanum, cerium, praseodymium, neodymium, samarium, europium, gadolinium, terbium, dysprosium, ytterbium, and lutetium, z ranges from zero to one, M is one or more elements chosen from titanium, vanadium, chromium, manganese, iron, cobalt, nickel, copper, zinc, yttrium, zirconium, niobium, molybdenum, ruthenium, rhodium, palladium, silver, tantalum, tungsten, rhenium, iridium, platinum, gold, bismuth, O is oxygen, and u ranges from 0.95 to six.

The coated component of any of the preceding clauses, such that the coated component is an aircraft component.

The coated component of any of the preceding clauses, such that the coated component is a gas turbine engine component.

The coated component of any of the preceding clauses, such that the coated component is a venturi surface, a fuel nozzle, a fuel circuit component, or an oil lube circuit component.

The coated component of any of the preceding clauses, such that the substrate is a metal substrate, a ceramic substrate, a metal substrate coated with a ceramic layer, or a ceramic substrate coated with a metal layer.

The coated component of any of the preceding clauses, such that the substrate is the metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

The coated component of any of the preceding clauses, such that the substrate is the metal substrate coated with the ceramic layer and the ceramic layer is a thermal barrier coating.

A method of oxidizing coke, the method including contacting the coke with the coated component of any of the preceding clauses at a temperature ranging from three hundred degrees Fahrenheit to one thousand one hundred degrees Fahrenheit.

A method of making the coated component of any of the preceding clasues, the method including spraying particles of the first ceramic material and the first noble metal on the substrate, wherein the particles of the first ceramic material and the first noble metal have an average particle diameter ranging from 0.5 micron to one micron, spraying particles of the second ceramic material and the second noble metal, wherein the particles of the second ceramic material and the second noble metal have a first plurality of particles having an average particle diameter ranging from 0.5 micron to one micron and a second plurality of particles having an average particle diameter ranging from four microns to twenty microns, spraying particles of the third ceramic material and the third noble metal, wherein the particles of the third ceramic material and the third noble metal have an average particle diameter ranging from 0.5 micron to two microns; and sintering at least some of the particles of the third ceramic material and the third noble metal at a temperature ranging from one thousand five hundred degrees Fahrenheit to two thousand degrees Fahrenheit.

The method of the preceding clause, such that the sintering step fuses the particles of the first ceramic material and the first noble metal to form the plurality of grains having the average diameter ranging from 0.5 micron to one micron in the first layer of the catalytic coating, the sintering step fuses the particles of the second ceramic material and the second noble metal to form the plurality of grains having the bimodal distribution with the first mode diameter ranging from 0.5 micron to two microns and the second mode diameter ranging from four microns to twenty microns in the second layer of the catalytic coating, and the sintering step fuses the particles of the third ceramic material and the third noble metal to form the plurality of grains having the average diameter ranging from 0.5 micron to two microns in the third layer of the catalytic coating.

The method of any of the preceding clauses, such that sintering includes applying heat to the catalytic coating and cooling the substrate on a side opposite the catalytic coating.

An embodiment of any of the preceding clauses, such that the first ceramic material, the second ceramic material, and the third ceramic material are independently chosen from metal oxides of formula (I) AₓE_{y}L_{z}MOᵤ where A is one or more alkaline earth elements chosen from, magnesium, calcium, strontium, and barium; x ranges from zero to one, E is one or more alkali metals chosen from lithium, sodium, potassium, y ranges from zero to one, L is one or more lanthanide elements chosen from lanthanum, cerium, praseodymium, neodymium, samarium, europium, gadolinium, terbium, dysprosium, ytterbium, and lutetium, z ranges from zero to one, M is one or more elements chosen from titanium, vanadium, chromium, manganese, iron, cobalt, nickel, copper, zinc, yttrium, zirconium, niobium, molybdenum, ruthenium, rhodium, palladium, silver, tantalum, tungsten, rhenium, iridium, platinum, gold, bismuth, O is oxygen, and u ranges from 0.95 to six.

An embodiment of the preceding clause, such that u ranges from 0.95 to 3.

An embodiment of any of the preceding clauses, such that A is barium or strontium.

An embodiment of any of the preceding clauses, such that E is lithium, sodium, or potassium.

An embodiment of any of the preceding clauses, such that L is lanthanum, cerium, praseodymium, neodymium, samarium, gadolinium, or ytterbium.

An embodiment of any of the preceding clauses, such that M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium.

An embodiment of any of the preceding clauses, such that the first ceramic material, the second ceramic material, and the third ceramic material are each independently chosen from Co₃O₄, NiₓCo₃₋ₓO₄, FeₓCo₃₋ₓO₄,CuₓCo₃₋ₓO₄,CrₓCo₃₋ₓO₄,Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1}_{-(x+y+z)]}CoO₃,LnₓLi_{y}Sr_{z}Ba_{[1}_{-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O_{3,} Fe₃O₄, ZnFe₂O₄, BiₓSn₁₋ₓOᵤ, InₓSn_{y}O_{z}, Bi₂O₃-Co₃O₄, and CeO₂.

An embodiment of any of the preceding clauses, such that the catalytic coating has been flash sintered.

An embodiment of any of the preceding clauses, such that the catalytic coating has been flash sintered by heating one side of the coating and cooling the opposite side of the coating.

An embodiment of any of the preceding clauses, such that the catalytic coating has been flash sintered by heating one side of the coating for one to ten heating cycles.

An embodiment of any of the preceding clauses, such that the sintering step is a flash sintering step.

An embodiment of any of the preceding clauses, such that the sintering step is a flash sintering step wherein one side of the coating is heated, and the opposite side of the coating is cooled.

An embodiment of any of the preceding clauses, such that the sintering step is a flash sintering step wherein the catalytic coating is heated on one side of the coating for one to ten heating cycles.

Although the foregoing description is directed to some exemplary embodiments of the present disclosure, other variations and modifications will be apparent to those skilled in the art, and may be made without departing from the disclosure. Moreover, features described in connection with one embodiment of the present disclosure may be used in conjunction with other embodiments, even if not explicitly stated above.

1. A coated component for coke abatement in a gas turbine engine, the coated component comprising:
a substrate; and
a catalytic coating including:
a first layer in contact with the substrate, the first layer comprising a first ceramic material and a first noble metal, wherein the first layer has a volume percent porosity;
a second layer in contact with the first layer, the second layer comprising a second ceramic material and a second noble metal, wherein the second layer has a plurality of grains having a multimodal size distribution, and the second layer has a volume percent porosity that is greater than the volume percent porosity of the first layer; and
a third layer in contact with the second layer, the third layer comprising a third ceramic material and a third noble metal, wherein the third layer has a volume percent porosity that is less than the volume percent porosity of the second layer.

2. The coated component of claim 1, wherein the first layer has a plurality of grains having an average diameter ranging from 0.5 micron to one micron and the volume percent porosity of the first layer ranges from ten percent to thirty percent,
the second layer has a bimodal grain size distribution with a first mode diameter ranging from 0.5 micron to two microns and a second mode diameter ranging from four microns to twenty microns, and the volume percent porosity of the second layer ranges from twenty percent to sixty percent, and
the third layer has a plurality of grains having an average diameter ranging from 0.5 micron to two microns and the volume percent porosity of the third layer ranges from five percent to thirty percent.

3. The coated component of claim 1, wherein the first ceramic material, the second ceramic material, and the third ceramic material have the same chemical composition.

4. The coated component of claim 1, wherein the first layer has a thickness ranging from 2.5 microns to fifteen microns.

5. The coated component of claim 1, wherein the second layer has a thickness ranging from twenty-five microns to fifty microns.

6. The coated component of claim 1, wherein the third layer has a thickness ranging from 2.5 microns to fifteen microns.

7. The coated component of claim 1, wherein each layer comprises a binder.

8. The coated component of claim 1, wherein each layer comprises a binder comprising silica.

9. The coated component of claim 1, wherein the coated component has a coating mass loss of less than seven weight percent when exposed to a jet of hot air having a temperature of one thousand one hundred degrees Fahrenheit and a velocity of one hundred and four liters per minute for one hour.

10. The coated component of claim 1, wherein the first ceramic material, the second ceramic material, and the third ceramic material are each independently chosen from metal oxides of formula (I) AₓE_{y}L_{z}MOᵤ where A is one or more alkaline earth elements chosen from, magnesium, calcium, strontium, and barium; x ranges from zero to one; E is one or more alkali metals chosen from lithium, sodium, and potassium; y ranges from zero to one; L is one or more lanthanide elements chosen from lanthanum, cerium, praseodymium, neodymium, samarium, europium, gadolinium, terbium, dysprosium, ytterbium, and lutetium; z ranges from zero to one; M is one or more elements chosen from titanium, vanadium, chromium, manganese, iron, cobalt, nickel, copper, zinc, yttrium, zirconium, niobium, molybdenum, ruthenium, rhodium, palladium, silver, tantalum, tungsten, rhenium, iridium, platinum, gold, and bismuth; O is oxygen; and u ranges from 0.95 to six.

11. The coated component of claim 1, wherein the coated component is an aircraft component.

12. The coated component of claim 1, wherein the coated component is a gas turbine engine component.

13. The coated component of claim 1, wherein the coated component is a venturi surface, a fuel nozzle, a fuel circuit component, or an oil lube circuit component.

14. The coated component of claim 1, wherein the substrate is a metal substrate, a ceramic substrate, a metal substrate coated with a ceramic layer, or a ceramic substrate coated with a metal layer.

15. The coated component of claim 14, wherein the substrate is the metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

16. The coated component of claim 14, wherein the substrate is the metal substrate coated with the ceramic layer and the ceramic layer is a thermal barrier coating.

17. A method of oxidizing coke, the method comprising:
contacting the coke with the coated component of claim 1 at a temperature ranging from three hundred degrees Fahrenheit to one thousand one hundred degrees Fahrenheit.

18. A method of making the coated component of claim 1, the method comprising:
spraying particles of the first ceramic material and the first noble metal on the substrate, wherein the particles of the first ceramic material and the first noble metal have an average particle diameter ranging from 0.5 micron to one micron;
spraying particles of the second ceramic material and the second noble metal, wherein the particles of the second ceramic material and the second noble metal have a first plurality of particles having an average particle diameter ranging from 0.5 micron to one micron and a second plurality of particles having an average particle diameter ranging from four microns to twenty microns;
spraying particles of the third ceramic material and the third noble metal, wherein the particles of the third ceramic material and the third noble metal have an average particle diameter ranging from 0.5 micron to two microns; and
sintering at least some of the particles of the third ceramic material and the third noble metal at a temperature ranging from one thousand five hundred degrees Fahrenheit to two thousand degrees Fahrenheit.

19. The method of claim 18, wherein the sintering fuses the particles of the first ceramic material and the first noble metal to form the plurality of grains having the average diameter ranging from 0.5 micron to one micron in the first layer of the catalytic coating, the sintering fuses the particles of the second ceramic material and the second noble metal to form the plurality of grains having a bimodal distribution with a first mode diameter ranging from 0.5 micron to two microns and a second mode diameter ranging from four microns to twenty microns in the second layer of the catalytic coating, and the sintering fuses the particles of the third ceramic material and the third noble metal to form the plurality of grains having the average diameter ranging from 0.5 micron to two microns in the third layer of the catalytic coating.

20. The method of claim 18, wherein sintering includes applying heat to the catalytic coating and cooling the substrate on a side opposite the catalytic coating.
